(19) United States
(12) Patent Application Publication
(10) Pub. No.: US 2012/0286950 A1
(43) Pub. Date: Nov. 15, 2012

(54) METHODS AND SYSTEMS FOR DETECTING THEFT OF AN ITEM

(75) Inventors: Nicholas J. PEARISO, Oak Park, MI (US); Russell A. PATENAUDE, Macomb Township, MI (US); Jeffrey P. CHRISTENSEN, Clinton Township, MI (US)

(73) Assignee: GENERAL MOTORS LLC, DETROIT, MI (US)

(21) Appl. No.: 13/104,836

(22) Filed: May 10, 2011

(51) Int. Cl. G08B 1/08

(52) U.S. Cl. 340/539.1

(57) ABSTRACT

Various examples of a method and a system for detecting theft of an item are disclosed herein. The method includes at least detecting with an aftermarket telematics unit a loss of electrical power being supplied to the aftermarket telematics unit and switching the aftermarket telematics unit to an alternate source of electrical power. The aftermarket telematics unit detects an occurrence of a second condition subsequent to detecting the loss of electrical power. The second condition may be a movement of the aftermarket telematics unit above a predetermined speed, or a diminution of strength of a wireless signal received from a component of the vehicle to below a predetermined threshold. The unit transmits a report containing information that is indicative of a theft event to a third party when the loss of electrical power and the occurrence of the second condition are detected.

### TECHNICAL FIELD

The technical field generally relates to detecting, and more particularly relates to detecting either theft of an aftermarket telematics unit mounted to a vehicle or theft of a vehicle equipped with an aftermarket telematics unit.

### BACKGROUND

Telematics services are services that are provided by a call center to a vehicle and/or to the operator of a vehicle that relate to various needs of the vehicle or the operator. Telematics services commonly include, but are not limited to, the remote monitoring of vehicle maintenance needs, the provision of turn by turn navigation guidance, the coordination of emergency services during vehicle emergencies, the provision of door unlock services when the vehicle's owner is locked out of the vehicle, and the provision of theft tracking services after a vehicle has been stolen, to name just a few.

A telematics service system conventionally includes a telematics unit mounted to the vehicle, a call center located remotely from the vehicle, and a communication network that communicatively connects the two. In a known example, the telematics unit is embedded in the vehicle (i.e., mounted to the vehicle during vehicle assembly) and directly connected to the vehicle bus. This connection to the vehicle bus permits the telematics unit to provide many of the telematics services (e.g., remote door unlock).

Aftermarket telematics units are also available in the market place. Such aftermarket telematics units make it possible for drivers of vehicles that lack an embedded telematics unit to, nevertheless, receive some or all of the available telematics services. In some applications, however, because of vehicle design, the aftermarket telematics unit is not directly connected to the vehicle bus. To accommodate this limitation, a vehicle communication interface (also known as a “dongle”) is provided to permit the aftermarket telematics unit to wirelessly communicate with the vehicle bus. The vehicle communication interface is configured to plug into an access port on the vehicle bus and to wirelessly communicatively pair with the aftermarket telematics, thereby giving the aftermarket telematics unit access to the vehicle bus.

One unfortunate situation that a vehicle owner may occasionally have to contend with is theft of the vehicle or theft of the aftermarket telematics unit from the vehicle. Accordingly, it is desirable to provide a system and method that utilizes the aftermarket telematics unit to detect theft of an item such as the aftermarket telematics unit while it is mounted to the vehicle or to detect theft of the vehicle itself. In addition, it is desirable to provide a system and method that utilizes the aftermarket telematics unit that can facilitate recovery of the stolen item. Furthermore, other desirable features and characteristics will become apparent from the subsequent detailed description and the appended claims, taken in conjunction with the accompanying drawings and the foregoing technical field and background.

### SUMMARY

Various examples of a method and a system for detecting theft of an item is disclosed herein. The item includes one of an aftermarket telematics unit mounted to a vehicle and the vehicle equipped with the aftermarket telematics unit.

In a first, non-limiting example, the method includes, but is not limited to, detecting with the aftermarket telematics unit a loss of electrical power being supplied to the aftermarket telematics unit. The method further comprises switching the aftermarket telematics unit to an alternate source of electrical power. The method further includes detecting with the aftermarket telematics unit an occurrence of a second condition subsequent to detecting the loss of electrical power. The second condition includes one of movement of the aftermarket telematics unit above a predetermined speed and diminution of strength of a wireless signal received from a component of the vehicle to below a predetermined threshold. The method still further includes transmitting with the aftermarket telematics unit a report containing information that is indicative of a theft event to a third party when the loss of electrical power and the occurrence of the second condition are detected.

In a second non-limiting example, the system includes, but is not limited to, a vehicle communication interface that is configured to connect to and communicatively couple with a vehicle bus of the vehicle and to transmit and receive wireless communications. The system further includes the aftermarket telematics unit. The aftermarket telematics unit is configured to draw electric power from the vehicle, to transmit and receive wireless communications, to wirelessly communicatively pair with the vehicle communication interface, to detect the occurrence of a first condition associated with the aftermarket telematics unit, to detect the occurrence of a second condition associated with the aftermarket telematics unit, and to transmit a report containing information that is indicative of a theft event to a third party when the occurrence of the first condition and the occurrence of the second condition are detected.

### DESCRIPTION OF THE DRAWINGS

One or more embodiments will hereinafter be described in conjunction with the following drawing figures, wherein like numerals denote like elements, and

FIG. 1 is a schematic view illustrating a non-limiting example of a telematics service system compatible for use with examples of the systems and methods disclosed herein for detecting theft of an item;

FIG. 2 is a schematic view illustrating an exemplary vehicle equipped with an example of a system for detecting theft of an item as disclosed herein;

FIG. 3 is a schematic view illustrating the system for detecting theft of an item illustrated in FIG. 2; and

FIG. 4 is a schematic view illustrating operation of the system illustrated in FIG. 3 when a theft has occurred; and

FIG. 5 is a block diagram illustrating an example of a method for detecting theft of an item as disclosed herein.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

Examples of methods and systems are disclosed herein that utilize an aftermarket telematics unit to detect the theft of the aftermarket telematics unit from a vehicle and to detect the theft of the vehicle itself. When a thief steals an aftermarket telematics unit that is mounted to a vehicle, the thief will typically sever the wire that carries electrical power to the aftermarket telematics unit in order to remove the aftermarket telematics unit from the vehicle. Similarly, when a thief steals a vehicle equipped with an aftermarket telematics unit, the thief will typically sever the wire that carries electrical power to the aftermarket telematics unit to disable the aftermarket telematics unit in an attempt to avoid detection and evade potential pursuers. Thus, in both circumstances, the aftermarket telematics unit will experience a sudden loss of electrical power.

When the aftermarket telematics unit suddenly loses electrical power, it is configured to switch over to a backup battery. The aftermarket telematics unit is further configured to detect the occurrence of a second condition. In an example, the second condition may comprise movement of the aftermarket telematics unit above a threshold speed (e.g., 30 mph) or the second condition may comprise a weakening or cessation of the wireless signal that is used to effect the wireless communicative pairing between the aftermarket telematics unit and the vehicle communication interface.

When the second condition comprises movement of the vehicle above a predetermined speed, the aftermarket telematics unit may be configured to determine that the vehicle itself is being stolen. This is because the sudden loss of electrical power to the aftermarket telematics unit will be interpreted as the vehicle being powered off. Movement of the aftermarket telematics unit above the predetermined speed, however, is inconsistent with the vehicle being powered off. Rather, movement of the aftermarket telematics unit above the predetermined speed after power has been lost is consistent with a scenario where the vehicle is being stolen and the thief has severed electrical wires that carry electrical power to the aftermarket telematics unit.

When the second condition comprises a weakening or cessation of the wireless signal that is used to effect the wireless communicative pairing between the aftermarket telematics unit and the vehicle communication interface, the aftermarket telematics unit may be configured to determine that the aftermarket telematics unit itself is being stolen. This is because the aftermarket telematics unit and the vehicle communication interface are mounted in the vehicle at locations that are substantially fixed relative to each other. It is therefore anticipated that the aftermarket telematics unit and the vehicle communication interface will remain at a substantially constant distance from one another, which, in turn, will lead to a substantially constant signal strength associated with the pairing between these two components. If the signal strength substantially weakens or ceases altogether, it can be concluded that the aftermarket telematics unit has been removed from the vehicle and that the distance between the aftermarket telematics unit and the vehicle communication interface is increasing. This would be consistent with theft of the aftermarket telematics unit. This could also be consistent with a situation where the aftermarket telematics unit has been removed from the vehicle and left behind while the vehicle is being stolen.

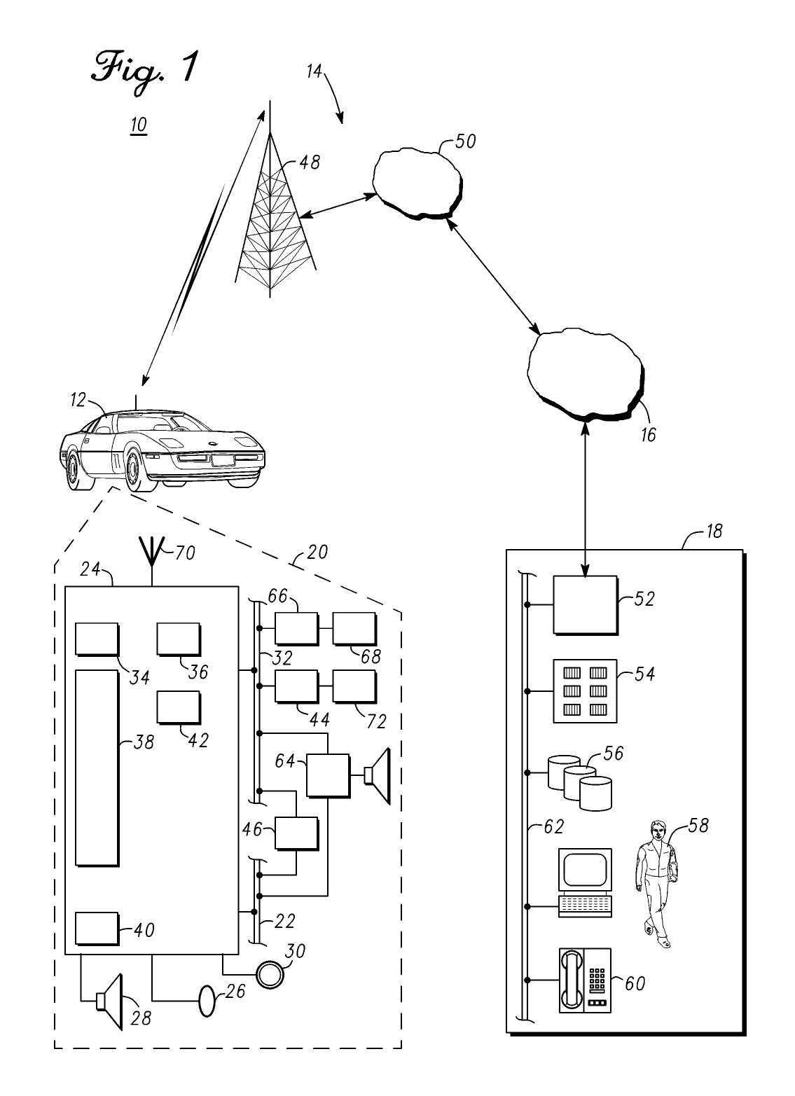

With reference to FIG. 1, there is shown a non-limiting example of a telematics service system 10 that may be used together with examples of the methods and systems for detecting theft of an item as disclosed herein. Telematics service system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated telematics service system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over telematics service system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GPS chipset/component 42. In one example, the wireless modem 36 includes a computer program and/or set of software routines adapted to be executed within electronic processing device 38.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. In order to enable successful data transmission over the voice channel, wireless modem 36 applies some type of encoding or modulation to convert the digital data so that it can be communicated through a vocoder or speech codec incorporated in the cellular chipset/component 34. Any suitable encoding or modulation technique that provides an acceptable data rate and bit error can be used with the present examples. Dual mode antenna 70 services the GPS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more components of the vehicle hardware 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either the advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a manned call center 18, it will be appreciated that the call center 18 can be any central or remote facility, manned or unmanned, mobile or fixed, to or from which it is desirable to exchange voice and data.

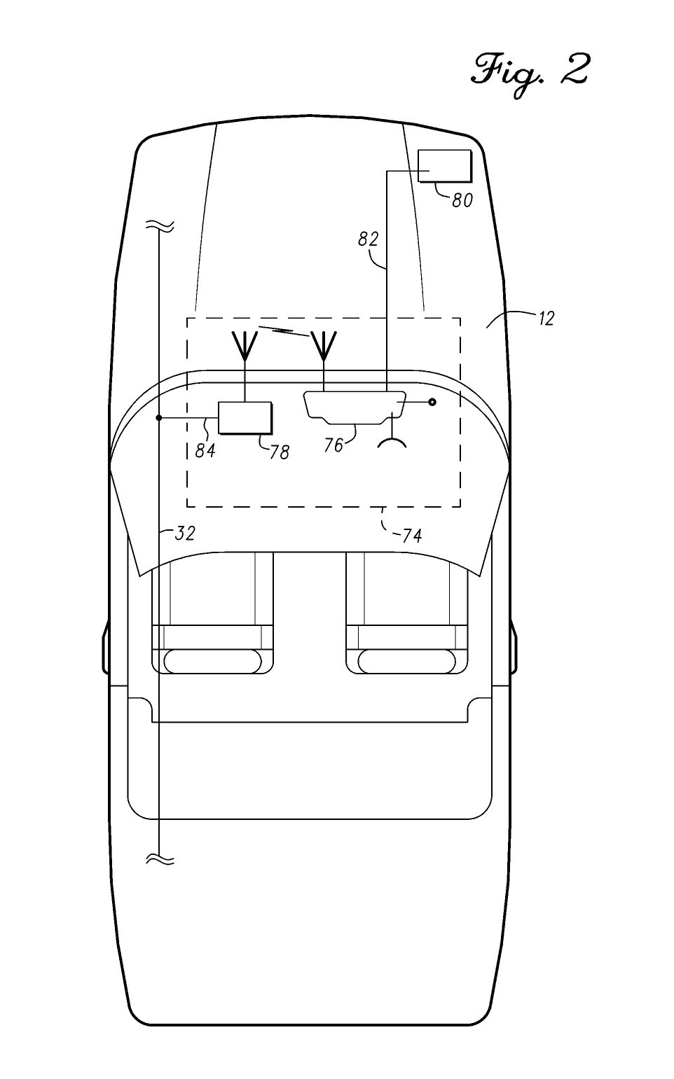

FIG. 2 is a schematic view illustrating vehicle 12 equipped with an example of a system 74 for detecting theft of an item. Although the illustrated example depicts system 74 installed in an automobile, it should be understood that system 74 may be compatible with other types of vehicles, including, but not limited to, watercraft, aircraft, and other types of land-based vehicles.

In the illustrated example, system 74 includes an aftermarket telematics unit 76 and a vehicle communication interface 78. In other examples, additional components may be included without departing from the teachings of the present disclosure.

Aftermarket telematics units such as aftermarket telematics unit 76 and vehicle communication interfaces such as vehicle communication interface 78 are both well-known in the art. Conventional aftermarket telematics units are disclosed in pending U.S. patent application Ser. No. 12/787,472 filed on May 26, 2010, and also in U.S. Publication No. 2005/0273211 published on Dec. 8, 2005, both of which are hereby incorporated herein by reference in their entirety. Examples of a vehicle communication interface include the ecoRoute™ HD, offered by Garmin under the part number 010-11380-00, the OBDLink Bluetooth Scan Tool offered by ScanTool.net LLC under the part number 4251BT, and the Wireless Bluetooth OBDII ELM 327 Code Reader Tool available from many retailers.

In the illustrated example, aftermarket telematics unit 76, and vehicle communication interface 78 are configured to be wirelessly communicatively paired with one another. As used herein, the term “wirelessly communicatively paired” refers to a communicative state between two components wherein each component will respond to wireless communications at a particular frequency or that employs a particular communications protocol only when those communications are sent from the other component of the pair and any communications received from a non-paired component will be ignored. Despite being paired, each component may, nevertheless, be able to wirelessly communicate with other components at different frequencies or utilizing different communication protocols.

Also illustrated in FIG. 2 is a vehicle battery 80. Vehicle battery 80 may comprise any suitable electric power source effective to provide the power necessary to operate aftermarket telematics unit 76. In an example, vehicle battery produces a substantially constant 12 Volts of direct current. In the illustrated example, aftermarket telematics unit 76 is directly connected to vehicle battery 80 via wire 82. In other examples, aftermarket telematics unit 76, may be indirectly connected to vehicle battery 80.

In the illustrated example, vehicle communication interface 78 is connected to vehicle bus 32 via wire 84. Wire 84, may be any type of wire effective to permit the transmission of signals between vehicle communication interface 78 and vehicle bus 32. Wire 84, facilitates a communicative connection between vehicle communications with a 78, and vehicle bus 32. Through vehicle bus 32, vehicle communication interface 78 may communicate with any system or component of vehicle 12 that is communicatively connected with vehicle bus 32. Through the wireless communicative pairing between aftermarket telematics unit 76 and vehicle communication interface 78, aftermarket telematics unit 76 may, likewise, communicate with any system or component of vehicle 12 that is communicatively connected with vehicle bus 32.

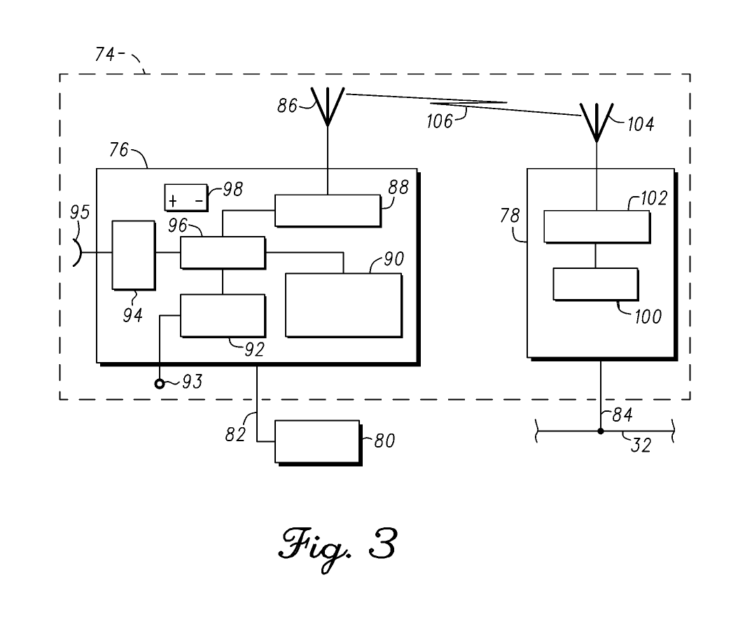

FIG. 3 is an expanded schematic view of system 74. With continuing reference to FIGS. 1-2, aftermarket telematics unit 76 may be substituted for telematics unit 24 in telematics system 10. In the illustrated example, aftermarket telematics unit 76 includes an antenna 86, a transceiver 88, an electronic data storage unit 90, a cellular chipset 92, a GPS chipset 94, a processor 96 and a backup battery 98. In other examples, aftermarket telematics unit 76 may include additional components without departing from the teachings of the present disclosure.

Transceiver 88 may be any type of wireless transceiver including a transceiver that is configured to communicate via radio frequency transmissions, infra red transmissions, or via any other wireless transmission effective to communicate a signal. In other examples of aftermarket telematics unit 76, a wireless transmitter and a wireless receiver may be used in lieu of a single device such as transceiver 88. In the illustrated example, transceiver 88 is coupled with antenna 86. Antenna 86 may be any device that is effective to propagate wireless signals originating from transceiver 88 and also to receive wireless signals originating from an external source. Although antenna 86 has been illustrated as being external to aftermarket telematics unit 76, it should be understood that antenna 86 may be mounted internally within aftermarket telematics unit 76.

Electronic data storage unit 90 is an electronic memory device that is configured to store data. Electronic data storage and 90 may be any type of data storage component including, without limitation, non-volatile memory, disk drives, tape drives, and mass storage devices and may include any suitable software, algorithms and/or sub-routines that provide the data storage component with the capability to store, organize, and permit the retrieval of data.

Cellular chipset 92 is functionally substantially identical to cellular chipset 34. Cellular chipset 92 enables aftermarket telematics unit 76 to communicate with third parties such as call center 18 over wireless carrier system 14. Antenna 93 is coupled with cellular chipset 92 and may be used to facilitate the transmission and reception of cellular telephone signals.

GPS chipset 94 is functionally substantially identical to GPS chipset/component 42. GPS chipset 94 enables aftermarket telematics unit 76 to provide turn by turn navigation assistance to a driver of vehicle 12 as well as the ability to provide other services available through the GPS navigation system. One such other service is the ability to determine the current location, speed, and heading a vehicle 12. Antenna 95 is coupled with GPS chipset 94 and may be used to facilitate the reception telecommunication signals.

Processor 96 may be any type of computer, computer system, microprocessor, collection of logic devices such as field-programmable gate arrays (FPGA), or any other analog or digital circuitry that is configured to calculate, and/or to perform algorithms, and/or to execute software applications, and/or to execute sub-routines, and/or to be loaded with and to execute any type of computer program. Processor 96 may comprise a single processor or a plurality of processors acting in concert.

Processor 96 is operatively coupled with transceiver 88, electronic data storage unit 90, cellular chipset 92, and GPS chipset 94. Through such operative couplings, processor 96 is enabled to control the activities of each coupled component. Processor 96 is configured to control the various components in a manner that enables aftermarket telematics unit 76 to provide a driver/occupant of vehicle 12 with some or all of the telematics services described above.

Backup battery 98 may comprise any suitable source of electric power effective to operate some or all of the components of aftermarket telematics unit 76 in the event of a discontinuation of electric power provided by vehicle battery 80. Backup battery 98 is typically less robust than vehicle battery 80 and may therefore be able to provide electric power to aftermarket telematics unit 76 for only a limited period of time.

Vehicle communication interface 78 comprises a processor 100, a transceiver 102, and an antenna 104. In the illustrated example, vehicle communication interface 78 is configured to receive electric power from vehicle bus 32 via wire 84. In other examples, vehicle communication interface 78 may comprise additional items without departing from the teachings of the present disclosure.

Processor 100 may be any type of computer, computer system, microprocessor, collection of logic devices such as field-programmable gate arrays (FPGA), or any other analog or digital circuitry that is configured to calculate, and/or to perform algorithms, and/or to execute software applications, and/or to execute sub-routines, and/or to be loaded with and to execute any type of computer program. Processor, 100 may comprise a single processor or a plurality of processors acting in concert.

Transceiver 102 may be any type of wireless transceiver including a transceiver that is configured to communicate via radio frequency transmissions, infra red transmissions, or via any other wireless transmission effective to communicate a signal. In other examples of vehicle communication interface 78, a wireless transmitter and a wireless receiver may be used in lieu of a single device such as transceiver. 102. In the illustrated example, transceiver 102 is coupled with antenna 104. Antenna 104 may be any device effective to propagate wireless signals originating from transceiver or to and also to receive wireless signals originating from an external source. Although antenna 104 has been illustrated as being external to vehicle communication interface 78, it should be understood that antenna will for, may be mounted internally within vehicle communication interface 78.

Processor 96 and processor 100 are each configured to control a transceiver 88 and transceiver 102, respectively, in a manner that permits aftermarket telematics unit 76 and vehicle communication interface 78 to be wirelessly communicatively paired. In a typical case, while vehicle 12 is being operated, vehicle battery 80 provides electric power directly to aftermarket telematics unit 76 and also provides electric power to vehicle communication interface 78 via vehicle bus 32. While vehicle 12 is being operated, aftermarket telematics unit 76 and vehicle communication interface 78 will each be powered on and will be wirelessly communicatively paired with one another. This wireless communicative pairing is schematically represented in FIG. 3 by signal 106 which has been illustrated in a solid line to indicate a relatively high strength. In some examples, the wireless communicative pairing between aftermarket telematics unit 76 and vehicle communication interface 78 may continue even after vehicle 12 has been powered off.

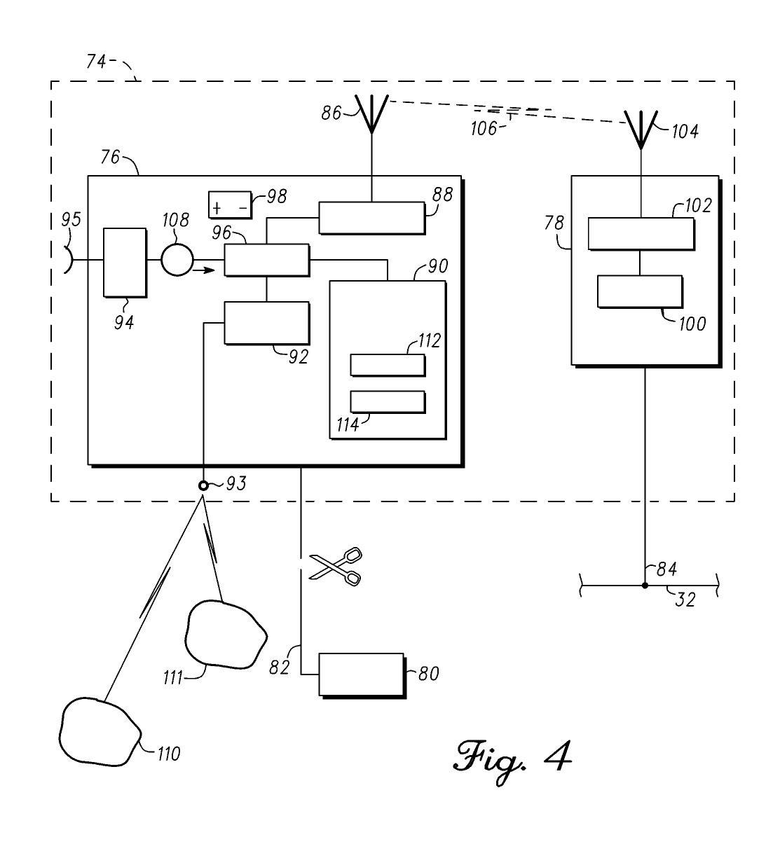

FIG. 4 is a schematic view illustrating a system 74 during the theft of either aftermarket telematics unit 76, or of the vehicle to which aftermarket telematics unit 76 is mounted. With continuing reference to FIGS. 1-3, in FIG. 4, wire 82, has been cut. The cutting of wire 82 results in the immediate cessation of the delivery of electric power from vehicle battery 80 to aftermarket telematics unit 76. Processor 96 is configured to detect the cessation of electric power delivery from vehicle battery 80 and is further configured to immediately cause aftermarket telematics unit 76 to draw power from backup battery 98. In some examples, because of the limited capacity of backup battery 98 to store electricity, processor 96 may be configured to power down aftermarket telematics unit 76 after a short time (e.g., five seconds). In some examples, this continued operability of aftermarket telematics unit 76 for a short time allows aftermarket telematics unit 76 to determine if vehicle 12 has been involved in a collision.

During the period subsequent to the interruption of delivery of electric power from vehicle battery 80, processor 96 is configured to obtain speed information 108 from GPS chipset 94 and is further configured to assess the strength of signal 106. Speed information 108, indicates the speed at which aftermarket telematics unit 76 is traveling. In some examples, if processor 96 is no longer able to obtain speed information 108 from GPS chipset 94 after wire 82 has been cut (e.g., the thief has removed, aftermarket telematics unit 76 from its mount and placed it in a position inside vehicle 12 were antenna 95 is unable to communicate with the GPS satellites), processor 96 may, nevertheless, be able to obtain information about the speed of vehicle 12 via the wireless communicative pairing between aftermarket telematics unit 76 and vehicle communication interface 78. This pairing allows aftermarket telematics unit 76 to obtain information pertaining to the dynamic condition of vehicle 12 from vehicle bus 32.

If aftermarket telematics unit 76 determines that it is traveling at a speed in excess of a predetermined speed, then processor 96 is configured to conclude that vehicle 12 is being stolen. In some examples, processor 96 may be configured to confirm this conclusion when the strength of signal 106 does not diminish after the loss of electric power from vehicle battery 80. In instances where there has been no diminution in the strength of signal 106, processor 96 can conclude that that there has been no relative movement between aftermarket telematics unit 76 and vehicle communication interface 78. This, in turn, allows processor 96, to conclude that vehicle 12 is moving at the same rate as aftermarket telematics unit 76 and is therefore being stolen.

In some examples, processor 96 may be further configured to determine whether the speed of vehicle 12 remains above the predetermined speed for a predetermined period of time (e.g. 10 seconds). By assessing whether the speed of aftermarket telematics unit 76 remains above the predetermined speed for the predetermined period of time, processor 96 reduces the likelihood of an error in the conclusion that vehicle 12 is being stolen by reducing the possibility that the speed information is an anomaly.

If, after the cessation of electric power from vehicle battery 80, processor 96 determines that the speed of aftermarket telematics unit 76 does not exceed a predetermined speed, but that the strength of signal 106 has diminished to below a predetermined threshold, aftermarket telematics unit 76 will conclude that aftermarket telematics unit 76 is being stolen from vehicle 12. A diminution in the strength of signal 106 is consistent with an increasing the distance between aftermarket telematics unit 76 and vehicle communication interface 78. Since these two components are designed to remain at a constant distance from one another, an increase in the distance between these two components is consistent with theft of the aftermarket telematics unit.

In some examples, processor 96 may be configured to assess whether speed information 108 is consistent with the speed at which a human can walk or run to provide further support for the conclusion that aftermarket telematics unit 76 is being stolen. In other examples, processor 96, may be configured to assess whether the strength of signal 106 remains below the predetermined strength for longer than a predetermined period of time. By waiting for a predetermined period of time to pass before concluding that aftermarket telematics unit 76 is being stolen, processor 96 reduces the likelihood of erroneously concluding that such a theft is occurring based on an anomalously low signal strength reading.

Once processor 96 has concluded that vehicle 12 has been stolen, processor 96 is further configured to instruct cellular chipset 92 to broadcast a theft report 110 to call center 18. As described above, such transmission may reach call center 18 via wireless carrier system 14. In other examples, theft report 110 may be broadcast over wireless carrier system 14 to other third parties in lieu of, or in addition to, call center 18.

Theft report 110 may include information indicating that either aftermarket telematics unit 76 or vehicle 12 has been stolen, as well as other information such as the time, date, and location when/where such that occurred. Theft report 110 may further include information indicative of a dynamic condition of aftermarket telematics unit 76. As used herein, the term “dynamic condition” shall refer to a current location, a current speed, and a current heading of aftermarket telematics unit 76. Processor 96 may be further configured to instruct electronic data storage unit 90 to store the information contained in theft report 110 in a data file 112. Such information would be accessible to anyone recovering aftermarket telematics unit 76 the capture, the criminal prosecution, and the conviction of the thief.

In another example, processor 96, may be configured to periodically instruct cellular chipset 92 to broadcast to call center 18 (or any other third party) a location report 111 that includes the dynamic condition of aftermarket telematics unit 76 as well as the time that such observations were made. In still other examples, processor 96 may be configured to instruct electronic data storage unit 90 to store a data file 114 or a plurality of data files 114, containing the dynamic condition of aftermarket telematics unit 76.

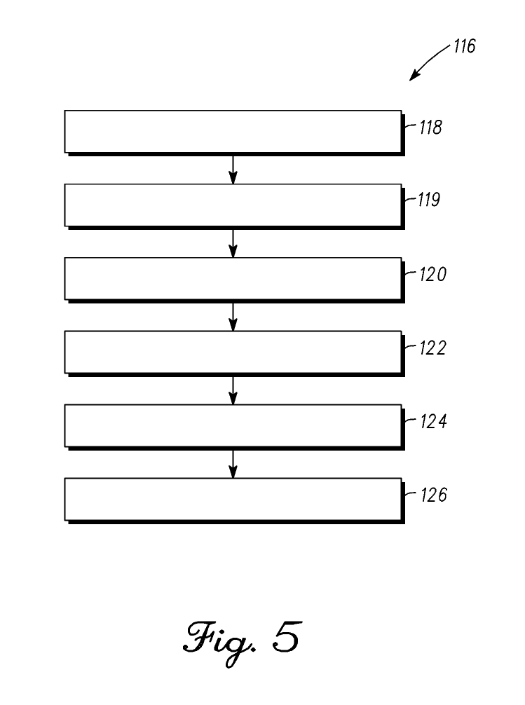

FIG. 5 is a block diagram illustrating an example of a method 116 for detecting either theft of an aftermarket telematics unit from a vehicle or theft of a vehicle to which the aftermarket telematics unit is mounted. With continuing reference to FIGS. 1-4, at block 118, a first condition is detected by the aftermarket telematics. In an example, the first condition comprises the cessation of electric power being provided to the aftermarket telematics unit by a vehicle battery of the vehicle to which the aftermarket telematics unit is mounted.

At block 119, the aftermarket telematics unit switches to an alternate source of electrical power. In one example, the aftermarket telematics unit may switch to an internally mounted backup battery.

At block 120, the aftermarket telematics unit detects the occurrence of a second condition. In an example, the second condition may comprise movement of the aftermarket telematics unit at a speed greater than a predetermined speed. When the aftermarket telematics unit is moving at a speed greater than the predetermined speed after there has been a cessation of power from the vehicle battery, this set of conditions suggests that the vehicle in which the aftermarket telematics unit is mounted is being stolen. In a variation, the second condition may comprise movement of the aftermarket telematics unit at a speed greater than the predetermined speed for a period of time that is greater than or equal to a predetermined period of time.

In another example, the second condition may be the diminution of the strength of the wireless signal by which the aftermarket telematics unit wirelessly communicatively pairs with another component of the vehicle such as the vehicle communication interface. When that signal strength diminishes to below a predetermined threshold after there has been a cessation of power from the vehicle battery, this set of conditions suggests that the aftermarket telematics unit has been moved a substantial distance from the other component of the vehicle which, in turn, is consistent with theft of the aftermarket telematics unit. In a variation, the second condition may comprise diminution of the signal strength to below a predetermined strength for a period of time that is greater than or equal to a predetermined period of time.

At block 122, after the occurrence of the two above described conditions, the aftermarket telematics unit transmits a theft report to a third-party indicating the occurrence of a theft event. Depending upon which set of conditions were detected by the aftermarket telematics unit, the aftermarket telematics unit will report either the theft of the aftermarket telematics unit itself from the vehicle or the theft of the vehicle, to which the aftermarket telematics unit is mounted.

In some examples, the third party may comprise call center 18 and the theft report may be transmitted to call center 18 via wireless carrier system 14. Upon receipt of such theft report, call center 18 may take any of a number of actions. In some examples, call center 18 may attempt to contact the owner of the vehicle 12. In other examples, call center 18 may attempt to contact an appropriate first responder. In another example, call center 18 may record the theft report for subsequent retrieval if and/or when the owner of vehicle 12 requests and/or requires assistance in recovering the stolen item.

At block 124, the aftermarket telematics unit may periodically transmit a location report to call center 18 or to another third party that includes the dynamic condition of the aftermarket telematics unit as well as the time when such observations were made.

At block 126, the aftermarket telematics unit may periodically store the information included in the theft report in its own internal memory. Information included in the theft report may be helpful in determining the whereabouts of the stolen item, as well as assisting in the prosecution of the thief.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A method for detecting theft of an item, the item comprising at least one of an aftermarket telematics unit mounted to a vehicle and the vehicle equipped with the aftermarket telematics unit, the method comprising:
detecting with the aftermarket telematics unit a loss of electrical power being supplied to the aftermarket telematics unit;
switching the aftermarket telematics unit to an alternate source of electrical power;
detecting with the aftermarket telematics unit an occurrence of a second condition subsequent to detecting the loss of electrical power, the second condition comprising one of the following:
a movement of the aftermarket telematics unit above a predetermined speed, and
a diminution of strength of a wireless signal received from a component of the vehicle to below a predetermined threshold; and
transmitting with the aftermarket telematics unit a report containing information that is indicative of a theft event to a third party when the loss of electrical power and the occurrence of the second condition are detected.

2. The method of claim 1, wherein the second condition comprises the movement of the aftermarket telematics unit above the predetermined speed and wherein the report contains information indicative of a theft of the vehicle.

3. The method of claim 2, wherein the second condition further comprises sustained movement of the aftermarket telematics unit above the predetermined speed for a predetermined period of time.

4. The method of claim 2, wherein the report further contains information indicative of a dynamic condition of the aftermarket telematics unit.

5. The method of claim 4, wherein the dynamic condition of the aftermarket telematics unit includes at least one of a location of the aftermarket telematics unit, a speed of the aftermarket telematics unit, and a heading of the aftermarket telematics unit.

6. The method of claim 1, wherein the second condition comprises the diminution of strength of the wireless signal received from the component of the vehicle to below a predetermined threshold and wherein the report contains information indicative of a theft of the aftermarket telematics unit.

7. The method of claim 6, wherein the second condition further comprises the diminution of strength of the wireless signal to below a predetermined threshold for longer than a predetermined period of time.

8. The method of claim 6, wherein the report contains information indicative of a dynamic condition of the aftermarket telematics unit.

9. The method of claim 8, wherein the dynamic condition of the aftermarket telematics unit includes at least one of a location of the aftermarket telematics unit, a speed of the aftermarket telematics unit, and a heading of the aftermarket telematics unit.

10. The method of claim 1, further comprising the step of periodically transmitting to the third party with the aftermarket telematics unit information relating to a location of the aftermarket telematics unit, such periodic transmissions commencing subsequent to transmission of the report.

11. The method of claim 1, further comprising the step of periodically recording at the aftermarket telematics unit information relating to a location of the aftermarket telematics unit, such periodic recordings commencing subsequent to transmission of the report.

12. The method of claim 1, wherein the third party comprises a call center.

13. A system for detecting theft of an item, the item comprising at least one of an aftermarket telematics unit mounted to a vehicle and the vehicle equipped with the aftermarket telematics unit, the system comprising:
a vehicle communication interface configured to connect to and communicatively couple with a vehicle bus of the vehicle and to transmit and receive wireless communications; and
the aftermarket telematics unit, wherein the aftermarket telematics unit is configured to draw electric power from the vehicle, to transmit and receive wireless communications, to wirelessly communicatively pair with the vehicle communication interface, to detect an occurrence of a first condition associated with the aftermarket telematics unit, to detect an occurrence of a second condition associated with the aftermarket telematics unit, and to transmit a report containing information that is indicative of a theft event to a third party when the occurrence of the first condition and the occurrence of the second condition are detected.

14. The system of claim 13, wherein the first condition comprises a loss of electrical power being supplied to the aftermarket telematics unit.

15. The system of claim 13, wherein the second condition comprises a movement of the aftermarket telematics unit above a predetermined speed.

16. The system of claim 13, wherein the second condition comprises sustained movement of the aftermarket telematics unit above a predetermined speed for a predetermined period of time.

17. The system of claim 13, wherein the second condition comprises a diminution of strength of a wireless communicative pairing between the vehicle communication interface and the aftermarket telematics unit to below a predetermined threshold.

18. The system of claim 13, wherein the second condition further comprises a diminution of strength of a wireless communicative pairing between the vehicle communication interface and the aftermarket telematics unit to below a predetermined threshold for longer than a predetermined period of time.

19. The system of claim 13, wherein the report contains information indicative of a dynamic condition of the aftermarket telematics unit.

20. The system of claim 19, wherein the dynamic condition of the aftermarket telematics unit includes at least one of a location of the aftermarket telematics unit, a speed of the aftermarket telematics unit, and a heading of the aftermarket telematics unit.
